(19) United States
(12) Patent Application Publication
(10) Pub. No.: US 2003/0136009 A1
(43) Pub. Date: Jul. 24, 2003

(54) Insitu apparatus and method for breaking glass

(76) Inventor: Ralph McNeill, East Kilbride (GB)

Correspondence Address: Fleshner & Kim, PO Box 221200, Chantilly, VA, 20153-1200, US

(21) Appl. No.: 09/959,875

(22) PCT Filed: Mar. 12, 2001
(86) PCT No.: PCT/GB01/01080

(30) Foreign Application Priority Data
Mar. 11, 2000 (GB) 0005765.3

(51) Int. Cl. B26F 1/00

(52) U.S. Cl. 30/361; 30/366

(57) ABSTRACT

A self-contained apparatus (1, 11) for breaking a glass pane, said apparatus comprising a housing (2) which can be attached to a glass pane (3), initiating means (4) breaking said glass pane and activation means (6) for encouraging the initiator to impact the glass with sufficient force to cause the glass pane to break or smash, wherein the apparatus can be retro-fitted to an existing window and is switchable between a sleep mode and active mode. The apparatus is further associated with identification means for aiding in the identification of a user upon activation of the apparatus which acts as an anti-vandalism system to prevent the device from being interfered with.

The present invention relates in general to apparatus that is used to break through glass in an emergency.

There has been recent criticism about the effectiveness of current emergency evacuation facilities in buildings and vehicles, particularly on trains following a number of fatal accidents.

With most modern vehicles and buildings the only exits are the doors and the windows. Many of the doors, especially on vehicles, are electrically operated and therefore fail to open or require a strong force to move them, in the event of loss of power. Also, in an emergency involving a large number of people there is often a bottleneck effect at the main exits which can lead to crushing.

In certain jurisdictions, including the United Kingdom, the windows on trains are legally required to be made of two sheets of toughened glass fox the very reason that this enables the windows to be sufficiently strong to avoid breaking by reason of impact, e.g from stone throwers, vibration stresses and so on.

While this is generally desirable, it can clearly represent a disadvantage when it is necessary to break the windows in order to provide an exit route.

At present, trains are equipped with a special hammer to break through the glass. However, this method is inefficient for a number of reasons. Firstly, the hammer may be difficult to access due to smoke or the failure of lights and it is not uncommon for the hammer to have been removed from its housing in an act of vandalism, Secondly, it requires a considerable effort to break toughened glass with such a hammer. Double glazed glass has a cushion of air between the panes of glass making the breakage of the glass extremely difficult. Furthermore, if the glass is laminated it is increasingly difficult to break.

In addition, the time taken to locate the hammer and break the glass can be several minutes; therefore constituting a real hazard should a person need to hurriedly break a pane of glass in an emergency.

In the prior art much effort has been directed at the development of emergency exits including methods of removing panes of glass and many improvements have been made to fulfil a variety of safety requirements.

U.S. Pat. No. 3,927, 492 discloses a quick release hinged vehicle window, which will permit outward swinging movement of the inner frame structure into an open position so as to provide an emergency exit. This window would have to be manually forced into a released position.

There are a number of hammer-like devices similar to Japanese Patent No. I1,042,290, ‘the Glass Crusher’ which describes an object of iron body with a plurality of radial projections made of steel or ceramic. The window is broken by hitting the glass with the spiked head of the implement. Although the instrument is stored in a rubber cap, it is a dangerous and a heavy object to use in an emergency. Also, it does not address the problem of locating the implement in a smoke filled room.

German Patent No. 3,925,430 discloses a pane of glass with a deformable hollow tube around the periphery of the frame which, when inflated with gas, releases the glass from the frame. An obvious problem associated with this design is the risk of the entire sheet of glass being ejected onto people.

Experts in safety believe that the chances of surviving a fire depend on being able to exit the burning area within the first two and a half minutes. Therefore it will be appreciated that there exists a continuing need for a quick, simple and effective method of breaking glass that allows people to exit or enter in an emergency and also deters vandals from disabling the apparatus.

In this respect, the device according to the present invention substantially departs from the conventional concepts and designs of the prior art. As such the general purpose of the present invention is to provide apparatus which breaks glass, including toughened and or laminated glass, instantly and easily and which has means for detering vandals from interfering with the apparatus.

It is an object of the present invention to provide a self contained apparatus for breaking glass and particularly toughened glass, which minimises the time taken to break the aforesaid glass in an emergency situation.

It is a further object of the present invention to provide a self contained apparatus for breaking glass that incorporates an anti-vandalism system to prevent the device from being interfered with.

It is a yet further object of the present invention to provide a self contained apparatus for breaking glass which can be retrofitted to glass in a quick and simple manner.

It is a yet further object of the-present invention to provide a self contained apparatus for breaking glass which may be portable and can be attached to the glass in an emergency situation.

According to the present invention there is provided a self-contained apparatus for breaking a glass pane, said apparatus comprising a housing which can he attached to the glass, initiating means for breaking said glass and an activation means for encouraging the initiator to impact the glass with sufficient force to cause the glass pane to break or smash.

Typically the initiating means can also break through multi-glass panes such as double glazing or reinforced glass, simultaneously.

Typically the activation means is located behind a protective panel or barrier, the panel or barrier being easily broken or removed to enable access to the activation means.

Optionally activation means can be positioned in a location remote from the apparatus.

Preferably, the initiator means is provided as a metal pin or rod.

Typically, the activator means incorporates a button accessable and operable by a user requiring immediate breaking of the glass pane.

In a preferred embodiment said activation means further includes a hot wire bridge by way of an electrical circuit, wherein the circuit is closed upon depression of the button or a switch operable by a user, the hot wire bridge being adapted to transfer heat to a compound located within the housing, wherein the compound is adapted to decompose on heating resulting in the rapid expansion of gases thereby serving to drive a piston to which said initiator means is linked, wherein the movement of said piston and initiator means causes said initiator means to forcibly impact the glass pane.

Preferably said compound is nitrocellulose.

Alternatively, the activation means may include means for encouraging the initiator means against a mechanical bias, whereby upon release of a button or switch by the user, the bias forcibly propels the initiating means to forcibly impact the glass pane.

Preferably the protective panel is a made of a material that is far easier to break or shatter than the glass pane sought to be broken by the initiating means, and which offers minimal risk of damaging the skin or tissue of the user or nearby personnel. The material may be SAFEGLASS™.

Optionally the apparatus is permanently fixed to the glass by way of a strong adhesive. This has the advantage that the apparatus may be provided with or retrofitted to the glass pane.

Alternatively the apparatus may be attached to the glass by suction means.

Alternatively the apparatus may be attached to the glass by mechanical means wherein said mechanical attachment means is in the fort of screws.

Preferably the apparatus includes Or is associated with an independent electrical power supply This may be provided in the form of batteries, wherein separate batteries are provided for each apparatus. The apparatus may therefore also include a battery power level LCD indicator and a suitable accessible lockable battery compartment.

Typically the housing is heat resistant.

Typically the housing is also resistant to radio frequency to ensure that the device is not inadvertently triggered.

In order to resist tampering or vandalism, the apparatus may be changeable between a “sleep mode” and an active mode, wherein when the apparatus is in said sleep mode the initiating means is not actuable by said activating means.

Switching between the sleep mode and the active mode may be dependent upon the output of one or more sensors associated with the apparatus. For example, motion sensors may be employed when the apparatus is utilised on a vehicle, and when motion of the vehicle is detected the apparatus is switched to said sleep mode. In this way, it is possible to enable activation of the device only when the vehicle is stopped.

Other sensors may additionally or alternatively be employed, including sound detectors and vibration sensors.

In a further alternative, the apparatus may be associated with or contain a sensor adapted to detect characteristics typical of emergency situations, such as excessive impact or deceleration, heat or smoke, wherein the detection of such characteristics is adapted to switch the apparatus from a default sleep mode to said active mode.

Optionally the sensors may be positioned in a location remote from the apparatus.

Preferably the apparatus contains self illumination means to allow identification of the apparatus in darkness.

The apparatus may be further associated with means for aiding in the identification of a user activating the apparatus. For example, the apparatus may contain a dye which is released upon activation of the apparatus Alternatively, the apparatus may be associated with a camera which is fired upon activation of the apparatus.

In order to provide a better understanding of the present invention, embodiments will now be described by way of example only with reference to the accompanying figures in which:

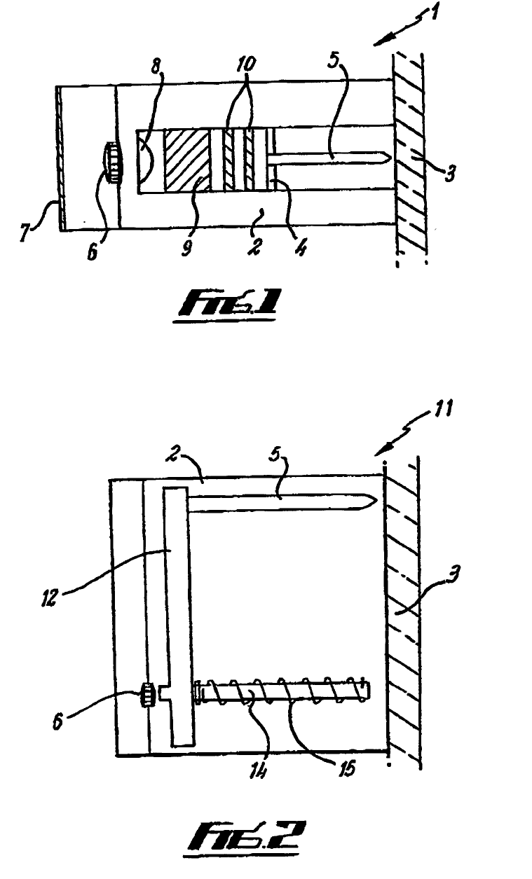

FIG. 1 illustrates a side view of a first example embodiment of apparatus in accordance with the invention; and

FIG. 2 illustrates a second alternative embodiment of the apparatus, incorporating a spring loaded lever.

Referring firstly to FIG. 1, apparatus for breaking a glass pane, generally depicted at 1, is comprised of a housing 2 which is attached to the toughened glass pane 3 or multi-glass panes sought to be broken. The glass pane 3 is a toughened glass window. The housing, 2 comprises a piston 4, metal rod 5, and button 6 Upon depression of the button 6, the metal rod 5 is propelled forcibly against the glass pane 3 in order to break or shatter the glass 3. The button 6, is located behind a protective panel 7 of SAFEGLASS™ which protects the button 6 from accidental release and acts as a deterrent against tampering of the apparatus 1 by vandals. As the protective panel 7 is made of SAFEGLASS™, it is easily breakable and offers minimal risk of damage to the skin of the person breaking the glass. The protective SAFEGLASS™ panel 7 is easier to break than the toughened glass pane 3 sought to be broken by the metal rod 5. However it is also recognised that alternatively the protective panel 7 may be made from another suitable material which can be easily broken or removed to allow access to the button 6.

Additional activation buttons 6 may be positioned in other locations remote form the apparatus 1. For example when the apparatus 1 is fitted to the window of a train, a number of activation buttons may be located in different locations along the walls of the carriage of the train.

The apparatus shown in FIG. 1 functions in the following manner. In an emergency situation, the protective panel 7 of SAFEGLASS™ can be easily smashed

with minimal risk of injury to the user in order to gain access to the button 6. Upon depression of the button 6 by the user, an electrical circuit within the apparatus 1 is closed which activates a hot wire bridge 8 within the housing 2. The hot wire bridge 8 heats instantaneously and transfers heat to a quantity of a chemical compound 9 which is also contained in the housing 2 within a number of seals 10. The chemical compound 9 may be nitrocellulose, although any other compound which decomposes upon heating could also be used Upon heating, the nitrocellulose 9 decomposes, resulting in a rapid expansion of gases which breaks the aforementioned seals 10 and drives the piston 5 and metal rod 4 forcibly forward onto the glass pane 3 thereby breaking or shattering the glass 3.

It is recognised that the present invention is particularly advantageous, in that because the apparatus is self-contained, it can be retrofitted to an existing window simply and quickly.

The housing 2 may be permanently fixed to the glass pane 3 by a strong adhesive which allows the apparatus 1 to be retrofitted for example on to the windows of existing rolling stock, vehicles or buildings. There is therefore no need to replace the existing windows of the vehicle or building, reducing the time and cost of installing or ‘fitting’ the apparatus 1. Alternatively, the housing 2 may be attached to the glass pane by suction pads (not shown) or the like. It will be appreciate that by using suction pads the apparatus 1 can be attached to a glass pane 3 very quickly. This is useful to the emergency services and in particular firemen who may wish to break a window on order to gain access into a burning building or vehicle.

Referring now to FIG. 2, an alternative embodiment of the apparatus is generally depicted at 11 and is comprised housing 2 attached to a glass pane 3, comprising a metal , and button 6. The housing 2, further comprises a lever 12 which can pivot at the centre of its length. A first end of the lever 12 connects to a stand 14 with a spring 15, whilst a second end is connected to the metal rod 5.

In this embodiment, depression of the button 6 encourages the first end of the lever 12 to be pressed towards the glass 3 thereby compressing the spring 15 on the stand 14. At the same tine the second end of the lever 12 is raised, drawing the metal rod 5 further from the glass surface 3. Upon release of the lever 12, the recoiling action of the spring 15 on the stand thrusts the metal rod 5 onto the glass pane 3 thereby breaking or shattering the glass.

It will be appreciated that an important aspect of the present invention is that the apparatus 1 has means for resisting tampering or vandalism. The first line of defence against misuse is that in order to activate the apparatus 1 the protective panel 7 must first be broken or removed. In some cases the requirement to willfully break this panel 7 may act as a psychological barrier to vandals. In addition, the apparatus 1 may also be changeable between a “sleep mode” in which the apparatus cannot be activated, and an active mode.

It will further be appreciated that when the apparatus is fitted to the windows of a train or other type of vehicle, it would be advantageous to activate the sleep mode when the train or vehicle is in motion in order to prevent misuse of the apparatus and ensure passenger safety. This is achieved by one or more sensors which are housed within the apparatus. For example the apparatus may comprise a motion sensor which can detect movement outside the window and therefore can switch the apparatus into the sleep mode when the vehicle is in motion. Alternatively the apparatus may include sound detectors, which would switch the apparatus to the sleep mode upon detecting the cyclic noises from carriage movement and vibration sensors which could immobilise the apparatus when the carriage is in motion.

Furthermore the apparatus may contain a sensor which upon detection of for example, smoke, excessive heat or a large impact, can automatically switch the apparatus to the active mode, or automatically activate the apparatus. The apparatus may also contain self illumination means to aid identification of the apparatus in the event that visibility within the train is impaired by smoke or failure of the lights.

The aforementioned sensors may be incorporated into the body of the apparatus or may be positioned in locations remote from the apparatus.

In the event that the apparatus is tampered with, identification of the user may be aided by incorporating a dye within the apparatus which is released upon activation. The dye may spray onto the user or may simply mark the user's finger on contact with the activation means. The apparatus may alternatively incorporate a camera which is fired upon activation of the apparatus. The camera may store images or transmit them to a central database for viewing. Alternatively, the apparatus may incorporate a video camera. The apparatus may also contain an alarm, which may be audible or visual and which activates when the apparatus is activated.

The present invention is inherent with significant advantages as the apparatus is safe to use as the protective panel which must be broken in order to activate the apparatus, is made from a material such as SAFEGLASS™ which when broken, shatters into fragments that are not capable of damaging human skin or tissue. Furthermore all components of the apparatus are self-contained and accordingly the time taken to break the glass in an emergency situation is greatly reduced over conventional methods which require the location of a hammer. The apparatus may also have self illuminating means to allow identification in emergency situations where electricity may be cut and smoke may be present.

The apparatus can also be fitted quickly and cost effectively to the existing windows of rolling stock and buildings. This is an advantage as the existing windows do not have to be removed and replaced The apparatus may also be positioned anywhere on a pane of glass. This is useful, as for example, fitting the apparatus high on the window will prevent young children from playing or tampering with the apparatus.

A yet further advantage is that the apparatus can be fixed permanently to a glass pane or may be used as a portable device that is fixed in an emergency situation. In fact, the apparatus may be provided as a lightweight portable apparatus with a carry-handle or attachment means to allow easy transportation. For example, it is envisaged that the apparatus described herewith will have particular relevance to the emergency services, for example to enable firemen or emergency services to access a building or vehicle.

A further advantage of the present invention is that it incorporates various anti-vandalism systems to prevent the device from being interfered with, and identify vandals who activate the apparatus in a non-emergency situation.

The above embodiments have been described for use on the windows of rolling stock, vehicles or buildings, but could readily be adapted for other applications. For example it is envisaged that the apparatus could be used in any place where it may be necessary to break a glass panel quickly, in an emergency situation. For example the apparatus may be fitted to fire extinguisher housings.

Further modifications and improvements may be added without departing from the scope of the invention herein intended.

1. Self-contained apparatus for breaking a glass pane, said apparatus comprising a housing which can be attached to the glass pane, initiating means for breaking said glass and an activation means for encouraging the initiator to impact the glass with sufficient force to cause the glass pane to break or smash.

2. Self-contained apparatus, as claimed in claim 1, wherein the initiating means can break through multi-glass panes, such as double glazing or reinforced glass, simultaneously.

3. Self-contained apparatus, as claimed in any one of the preceding claims, wherein the activation means is located behind a protective panel or barrier, the panel or barrier being easily broken or removed to enable access to the activation means.

4. Self-contained apparatus, as claimed in any one of the preceding claims, wherein the activation means is positioned in a location remote from the apparatus.

5. Self-contained apparatus, as claimed in any one of the preceding claims, wherein the initiating means is a metal pin or rod.

6. Self-contained apparatus, as claimed in any one of the preceding claims, wherein the activating means incorporates a button or switch accessible and operable by a user requiring immediate breaking of the glass pane.

7. Self-contained apparatus as claimed in any one of the preceding claims, wherein the activation means further includes a hot wire bridge by way of an electrical circuit, wherein the circuit is closed upon depression of the button or a switch operable by a user, the hot wire bridge being a adapted to transfer heat to a compound located within the housing, wherein the compound is adapted to decompose on heating, resulting in the rapid expansion of gases, thereby serving to drive a piston to which said initiator means is linked, wherein movement of said piston and initiator means causes said initiator means to favourably impact the glass pane.

8. Self-contained apparatus, as claimed in claim 7, wherein the compound is nitro-cellulose.

9. Self-contained apparatus, as claimed in any one of claims 1 to 6, wherein the activation means encourages the initiating means against a mechanical bias, whereupon release of a button or switch by the user, the bias forcibly propels the initiating means to forcibly impact the glass pane.

10. Self-contained apparatus, as claimed in claim 3, wherein the protective panel is made of a material which is far easier to break or shatter than the glass pane sought to be broken by the initiating means, and which offers minimal risk of damaging the skin or tissue of the user or nearby personnel.

11. Self-contained apparatus, as claimed in claim 10, wherein the material is SAFEGLASS™.

12. Self-contained apparatus, as claimed in any one of the preceding claims, wherein the apparatus is permanently fixed to the glass by way of a strong adhesive.

13. Self-contained apparatus, as claimed in any one of the preceding claims, wherein the apparatus is attached to the glass by suction means.

14. Self-contained apparatus, as claimed in any one of the preceding claims, wherein the apparatus is attached to the glass by mechanical means in the form of screws.

15. Self-contained apparatus, as claimed in any one of the preceding claims, wherein the apparatus includes or is associated with an independent electrical power supply.

16. Self-contained apparatus, as claimed in claim 15, wherein the independent electrical power supply is in the form of batteries.

17. Self-contained apparatus, as claimed in claims 15 to 16, wherein the apparatus includes a battery power level LCD indicator and a suitable accessible lockable battery compartment.

18. Self-contained apparatus, as claimed in any one of the preceding claims, wherein the housing is heat resistant.

19. Self-contained apparatus, as claimed in any one of the preceding claims, wherein the housing is resistant to radio frequency to ensure that the device is not inadvertently triggered.

20. Self-contained apparatus, as clashed in any one of the preceding claims, wherein the apparatus is changeable between a sleep mode and active mode, wherein when the apparatus is in said sleep mode, the initiating means is not actuable by said activation means.

21. Self-contained apparatus, as claimed in claim 20, wherein switching between the sleep mode and active mode is dependent upon the output of one or more sensors associated with the apparatus, such as motion sensors, sound detectors, vibration sensors, impact sensors, heat sensors or smoke sensors.

22. Self-contained apparatus, as claimed in claim 21, wherein the sensors are positioned in a location remote from the apparatus.

23. Self-contained apparatus, as claimed in any one of the preceding claims, wherein the apparatus contains self-illumination means to allow identification of the apparatus in darkness.

24. Self-contained apparatus, as claimed in any one of the preceding claims, wherein the apparatus is associated with identification means which aids in the identification of the user upon activation of the apparatus.

25. Self-contained apparatus, as claimed in claim 24, wherein the identification means is a dye which is released upon activation of the apparatus.

26. Self-contained apparatus, as claimed in claim 24, wherein the identification means is a camera which is fired upon activation of the apparatus.

27. Self-contained apparatus, as claimed in any one of the preceding claims, wherein the apparatus can be retro-fitted to a glass pane.
